(19) United States
(12) Patent Application Publication
(10) Pub. No.: US 2003/0146603 A1
(43) Pub. Date: Aug. 7, 2003

(54) Air bag housing and method of making

(76) Inventors: Timothy G. Basner, Centerville, OH (US); Bassam G. Khoudari, Shelby Township, MI (US)

Correspondence Address: KATHRYN A. MARRA, ESQ., DELPHI TECHNOLOGIES, INC., Legal Staff, Mail Code: 480-414-420, P.O. Box 5052, Troy, MI, 48007-5052, US

(21) Appl. No.: 10/072,048

(22) Filed: Feb. 6, 2002

(51) Int. Cl. B60R 21/16

(52) U.S. Cl. 280/728.2

(57) ABSTRACT

An air bag housing for use with an air bag inflator is provided. The air bag housing is formed from an elastically deformable material. The air bag housing comprises a cushion area, an inflator area, and an inflator locking mechanism. The cushion area is configured to receive an inflatable cushion in an un-inflated state. The inflator area is configured to receive the air bag inflator. The inflator area defines a receiving area that conforms to a cross section or exterior configuration of the inflator. The housing and the receiving area flex and elastically deform from an open position to a closed position. The inflator locking mechanism locks the housing and receiving area in the closed position securing the inflator therein.

### TECHNICAL FIELD

This application relates generally to air bags for vehicles. More specifically, this application relates to an air bag housing and method of manufacture.

### BACKGROUND

Air bags have become common in modem automobiles. An air bag module including a housing, an inflatable cushion, and an inflator is installed in the desired position within the vehicle. The cushion is stored in a folded position within the housing. The inflator is also stored in the housing and is in fluid communication with the cushion. In response to a threshold event or occurrence, a sensor provides a signal for activating the inflator. The inflator provides a means for inflating the inflatable cushion (e.g. supplying inflating gas to inflate the cushion).

There are several types of air bag modules, typically the air bag modules are configured for particular applications. For example, driver side air bags, passenger side air bags and side air bags to name just a few. The configuration or type of air bag module determines the assembly steps and/or process necessary to assemble the same.

For example, a passenger side air bag module (PAB) is typically assembled by inserting an inflator in an open end of an elongated housing and passing a securing post through an opening in the housing. The inflator is then secured to the housing by placing a locking nut over the portion of the threaded post extending outside of the housing.

Accordingly, an air bag module having a housing and inflator arrangement of this type requires several steps to secure the inflator in the housing.

It is desirable to have an airbag module with a housing and inflator configuration that contributes to economics of size as well as cost to manufacture. In addition, it is desirable to have a housing and inflator arrangement wherein the two are quickly assembled together.

### SUMMARY

A method of securing an inflator in an air bag housing is provided. The method includes inserting the inflator in an inflator area of the air bag housing, applying a closing force to the air bag housing to elastically deform the inflator area about the inflator, and locking the air bag housing in a closed position to secure the inflator in the inflator area.

An air bag housing for use with an air bag inflator is provided. The air bag housing comprises a cushion area, an inflator area, and an inflator locking mechanism. The cushion area is configured to receive an inflatable cushion. The inflator area is configured to receive the air bag inflator. The inflator area has a wall defining a receiving area that conforms to a cross section of the air bag inflator. The wall flexes or elastically deforms from an open position to a closed position upon the application of a closing force. The inflator locking mechanism locks the inflator area in the closed position maintaining the receiving area around the inflator thereby securing the inflator in the inflator area.

A method of increasing the structural rigidity of an air bag housing is provided. The method comprises forming the air bag housing with an inflator area, a cushion area and a locking mechanism, applying a closing force, and locking the air bag housing in a closed position with the locking mechanism. The inflator area has a wall configured to elastically deform between an open and a closed position. The closing force deforms the wall to the closed position.

The above-described and other features will be appreciated and understood by those skilled in the art from the following detailed description, drawings, and appended claims.

### BRIEF DESCRIPTION OF THE DRAWINGS

FIG. 1 is a side cross-sectional view of an air bag module within a cavity;

FIG. 2 is a side view of an inflator;

FIG. 3 is a side view of an inflator for use in the present disclosure;

FIG. 4 is a perspective view of an exemplary embodiment of an air bag housing and an inflator locking mechanism;

FIG. 5 is a first side view of the air bag housing and inflator mechanism of FIG. 4 in an open position;

FIG. 6 is a second side view of the air bag housing and inflator mechanism of FIG. 4 in a closed position;

FIGS. 7-9 illustrate the various positions of the inflator locking mechanism of FIG. 4;

FIGS. 10-11 illustrate an alternate embodiment of the inflator locking mechanism of FIG. 4;

FIG. 12 is a perspective view of an alternative embodiment of an air bag housing and an inflator locking mechanism;

FIG. 13 is a side view of another alternative embodiment of the present disclosure;

FIGS. 14-16 illustrate the various positions of the inflator locking mechanism of FIG. 13;

FIG. 17 is a side view of another alternative embodiment an inflator locking mechanism;

FIG. 18 is a side view of yet another alternative of the present disclosure;

FIGS. 19-20 illustrate the various positions of the inflator locking mechanism of FIG. 18;

FIG. 21 is a side view of another alternative embodiment of the present disclosure; and

FIG. 22 is a side view of another alternative embodiment of the present disclosure.

### DESCRIPTION OF THE PREFERRED EMBODIMENT

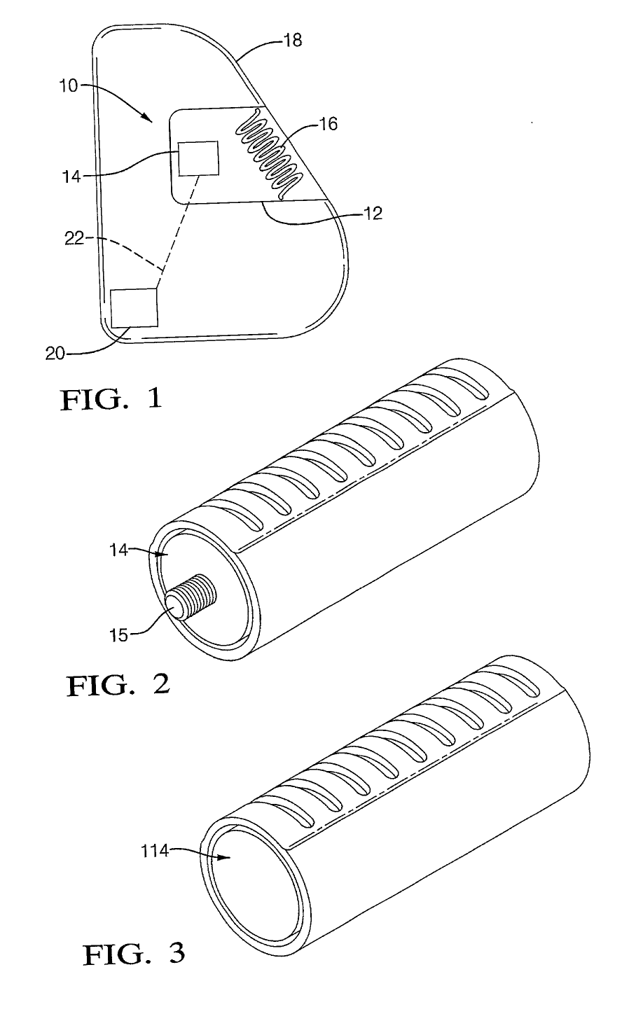

Referring to FIGS. 1 and 2, and in order to provide an example of a passenger side air bag device an air bag module 10 is illustrated. Air bag module 10 is adapted to be received and secured within a cavity 11 of the vehicle. Cavity 11 is located with an interior surface of a vehicle. Cavity 11 and the securement of module 10 therein fixedly positions the air bag device, for deployment of the air bag into a preferred location. Module 10 includes among the elements, a housing 12, an inflator 14 and an inflatable cushion 16.

A sensor 20 or a plurality of sensors is/are adapted to detect vehicle conditions and if necessary, provide an activation signal to inflator 14. In accordance with known techniques the inflator provides an inflation force to the inflatable cushion. Alternatively, sensor or sensors 20 provide signals to a sensing and diagnostic module (not shown), which controls the deployment of the air bag by receiving a plurality of signals and determining whether the air bag should be deployed. Cushion 16 is stored in a folded or un-inflated position within housing 12 and is in fluid communication with inflator 14. Thus, upon receipt of an activation signal, inflator 14 provides an inflation force to cushion 16.

Inflator 14 is illustrated in FIG. 2. The inflator 14 illustrated in FIG. 2 is adapted to be secured in a housing by passing a threaded post 15 through an opening in the housing. Securement is facilitated through the use of a locking nut configured for receipt on a portion of threaded post 15 protruding from one end of the housing as the inflator is inserted therein.

However, it has been determined that such protruding posts 15 add additional cost and expense to module 10. More specifically, it has been determined that post 15 add an additional length to the housing as the post and locking nut must be accommodated by the design. In addition to adding undesired length the post and nut locking add additional weight to module 10. Furthermore, the step of securing the locking nut (not shown) on the protruding post undesirably increases manufacturing time and difficulty.

The present disclosure is directed to an airbag module having a housing with an elongated body portion wherein an inflator can be inserted and retained therein without the use of an external securement means that would require the overall length of the module to be increased. Thus, the housing of the present disclosure provides an air bag module of a shorter overall length as the length of the inflator is reduced.

The housing is formed from a manufacturing process, which allows the housing (e.g. exterior walls and securement features) to be molded, extruded, pulltruded, cast, stamped or other equivalent manufacturing process wherein the housing is formed from a material having a flexible characteristic while also retaining a resiliency quality. Accordingly, the housing is capable of being flexed or deformed from a first position (open position) to a second position (closed position) and the characteristics and configuration of the housing will cause the same to provide a biasing force back towards the open or un-deformed position. The biasing force is also used to retain the housing in its locked position.

The housing is configured to have a securement mechanism(s) configured to lock or retain the housing in the second position. The configuration and materials of the housing and the securement mechanism allows the biasing force to retain the housing in a locked position as well as retaining an inflator therein without a securement stud fixed to the inflator.

In an exemplary embodiment, housing 112 is made from a straight section of extruded aluminum or other composite extrusion.

Referring now to FIGS. 3-11, an exemplary embodiment of an inflator 114 for use with an exemplary embodiment of a housing 112 is shown. As illustrated in FIG. 3, inflator 114 does not have a threaded post, feature or appendage required to secure the inflator in housing 112. As will be disclosed herein it is the housing itself which will secure the inflator therein. Thus, in accordance with the present disclosure housing 112 provides a quick and efficient means for securement of the inflator therein in as there is no requirement for separate securement step. In addition, the overall length the air bag module is reduced. The inflator of FIG. 3 is just an example of an inflator configuration without a securement stud. Other inflator configurations wherein the configuration and position of the diffusion openings and the inflator is varied are contemplated to be within the scope of the present disclosure.

Housing 112 defines an inflator area 124 and a cushion area 126. Housing 112 is adapted to be fluidly sealed by end plates such that inflator 114 is secured in inflator area 124 and in fluid communication with cushion 116. Cushion 116 is secured in cushion area 126 by a securement means which secures a portion of the inflatable cushion to a securement feature 137 of the housing. For example, feature 137 may be a key way configured for receiving a plastic rod (not shown) that will be inserted into a loop sewn into the end of the air bag, the loop being inserted into the key way prior to the insertion of the rod therein. Other examples of securement features feature are shown in U.S. Pat. No. 5,931,489.

In an alternate embodiment and as illustrated by the dashed lines in FIG. 3, inflator 114 is configured to have a locating feature or notch 117. Feature 117 provides an area configured to receive and engage a complimentary protrusion or locating feature 119 positioned on the interior surface of the receiving area of the housing. Locating feature 119 and the position of notch 117 allows inflator 114 to be easily located in the correct orientation (e.g. positioning of different openings of the inflator).

For example, if the inflator is configured to have a preferred orientation with respect to the inflatable air bag (e.g. diffuser openings on one side of the module) the inflator is easily positioned in the proper location prior to its securement therein.

In an exemplary embodiment housing 112 is formed by an extrusion process whereby an elongated channel or member having the configuration of housing 112 is formed. Thus, in accordance with this procedure an extruded channel is then cut into multiple pieces each representing a housing 112. Accordingly, the length of housing 112 is easily controlled as it is cut from the elongated channel. In accordance with an exemplary embodiment housing 112 is extruded aluminum.

Housing 112 is extruded with features to facilitate the securement of an inflator and inflatable air bag therein. The features may also include a channel 137 for receipt of a portion of the air bag cushion which is retained therein by a pin, for example the securement means illustrated in U.S. Pat. No. 5,931,489.

In addition, and as will be discussed below housing is made of an easily molded material that is capable of being deformed in a first direction whereby the inherent qualities of the material which the housing is formed from causes the material to return or to try to return to its original position.

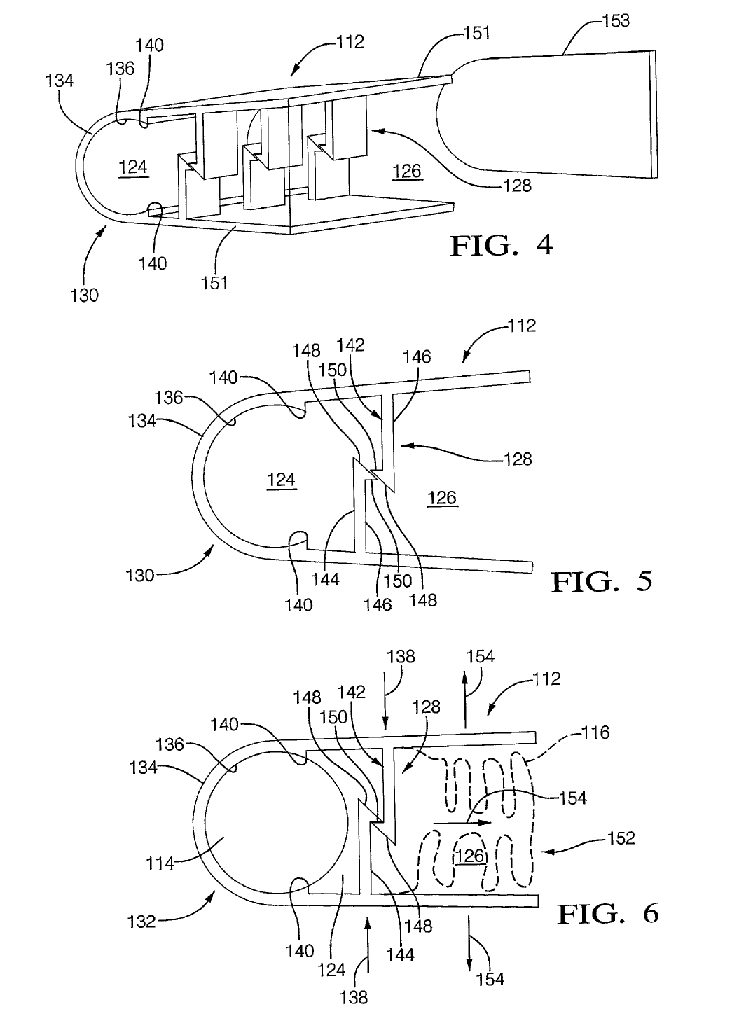

Housing 112 is illustrated in an open or unlocked position 130 in FIGS. 4 and 5, and is illustrated in a closed or locked position 132 in FIG. 6. Housing 112 includes one or more spaced apart housing locking mechanisms 128 configured to lock the housing in closed position 132. Thus, mechanisms 128 are configured to work in conjunction with inflator area 124 to apply a retaining force to retain the inflator therein. In this manner, housing 112 removes the need for the protruding posts and locking nut of prior air bag modules by applying a compressive or retention force on inflator 114 in inflator area 124.

Inflator area 124 includes a wall portion 134 that defines a portion of a receiving area 136. A pair of sidewalls 135 extend from wall portion 134. Wall 134 is configured to flex or elastically deform from open position 130 to closed position 132 upon the application of a force in the direction of arrow 138. Mechanism 128 locks or retains wall portion 134 and sidewalls 135 in closed position 132. In open position 130, receiving area 136 is larger than inflator 114. This allows for insertion of the inflator into the receiving area from either end of the housing. However, in closed position 132 receiving area 136 is reduced in size such that the receiving area applies a compressive or retention force on inflator 114 to secure the inflator in inflator area 124. Thus, in closed position 132 receiving area 136 conforms to the desired cross sectional shape of inflator 114.

In the example illustrated, inflator 114 has a circular cross sectional shape, thus area 136 as illustrated is shaped appropriately to conform to the circular cross section of the inflator. Of course, and as other applications require, inflator 114 and area 136 having conforming cross sections other than circular, such as, but not limited to, square, rectangular, oblong, and the like are considered within the scope of the present disclosure.

Also illustrated in FIGS. 3-6, an alternate embodiment of receiving area 136 is shown. Here, receiving area 136 further includes integrally formed retaining formations 140. Formations 140 provide an extension of the surface area of housing 112 that defines receiving area 136. Accordingly, and in applications where receiving area 136 is circular in shape formations 140 provide an extension of the circular area of receiving area 136. Formations 140 increase the amount of surface area of receiving area 136 that conforms to the cross section of inflator 114. Thus, formations 140 distribute the retaining forces across a greater surface of inflator 114 thereby increasing the grasp housing 112 has on the inflator. In addition, formations 140 also provide a means for retaining inflator 114 in its preferred location prior to the application of the compressive forces.

Locking mechanisms 128 are shown in detail in FIGS. 4-9. Each mechanism 128 includes a set of integrally formed locking arms 142 and 144 extending from opposing sidewalls 135. Arms 142 and 144 each include a transverse section 146, a mating face 148 and a locking face 150.

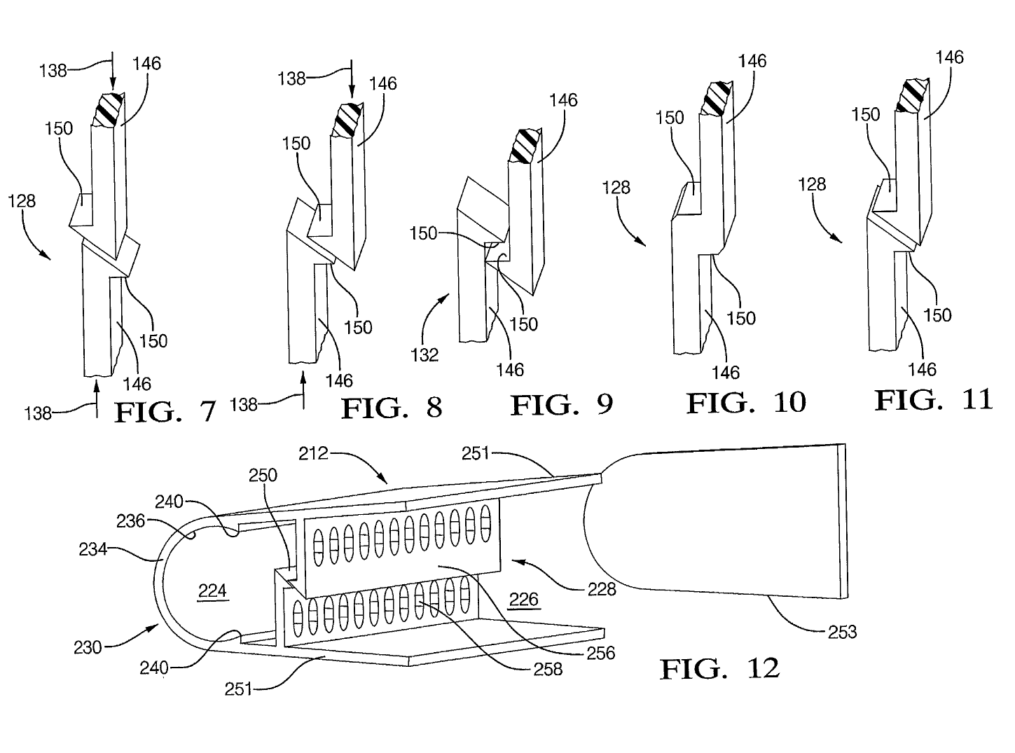

Mating faces 148 are configured to act upon one another as the housing is flexed to move housing 112 from open position 130 (FIG. 7) towards closed position 132 (FIG. 9). Traverse sections 146 and the material they are made of are configured to flex or elastically deform. Accordingly, mating faces 148 act upon one another to cause sections 146 to deform (FIG. 8) such that arm 142 moves in a first direction, while arm 144 moves in a second, opposite direction. Once housing 112 has moved equal to or slightly past closed position 132, the configuration of mating faces 148 and the length of sections 146 causes them to cease to act on one another. At this point, the elastic or resilient qualities of the materials traverse sections 146 are made of cause arms 142 and 144 to return to an unbiased state (e.g. their original position) to place locking faces 150 into a faced relationship with one another.

Upon the release of the closing force the housing is configured with a biasing force back towards the open position 130. This is due at least in part to the memory or resilient qualities of the materials as well as inflator 114 being inserted therein. Thus, the resiliency of the material housing 112 is made out of causes housing 112 to remain in a closed or locked position as the locking faces are biased back towards one another to lock housing 112 in the closed position.

During assembly, inflator 114 is inserted into inflator area 124 while housing 112 is in open position 130 (FIG. 3). Inflator 114 is axially inserted into inflator area 124 through one of the open ends of housing 112. Next, a closing force in the direction of arrow 138 is applied to housing 112 by hand or a machine to move sidewalls 135 towards each other.

This movement causes transverse sections 146 to deform as a result of mating faces 148 making contact with each other until locking faces 150 are placed into a faced relationship with one another. Once the housing closing force is released the sidewalls bias back towards the open position however, the locking faces of the locking mechanism have an interference fit with each other and further movement is prevented. Accordingly, and in this manner inflator 114 is secured in housing 112.

After locking the housing in the closed position, cushion 116 is installed (shown in phantom in FIG. 6). Cushion 116 is installed in a folded position or un-inflated state within cushion area 126. Cushion 116 is installed in a known manner so that it is in fluid communication with inflator 114 via the spaces between mechanisms 128. Next, side openings 151 of housing 112 are sealed by end plates 153 (shown in FIG. 4). End plates 153 will also provide a structural rigidity to housing 112 as well as a means for retaining inflator 114 therein. End plates 153 are secured to the housing 112 by connection means including but not limited to the following items: bolts, screws, welds, clips, and equivalents thereof. The connecting means is configured for receipt in a feature of housing 112.

Mechanism 128 also provides structural rigidity to housing 112. More specifically, and during deployment of the air bag module, activation of inflator 114 in module 110 increases the pressure in inflator area 124 and cushion area 126 to deploy cushion 116. The activation of inflator 114 creates an internal pressure. This pressure exerts a force in the direction of arrow 154. However, the locking faces of the locking mechanism prevent movement of the walls of the housing. Accordingly, mechanism 128 will provide additional rigidity to housing 112.

Referring now to FIGS. 10 and 11, an alternate embodiment of mechanism 128 is shown. Here, housing 112 is initially formed from an extrusion or molding process such that mating faces 148 and locking faces 150 of mechanism 128 are formed from a single piece by cutting a pre-molded item (FIG. 10). Thus, in this embodiment, the portions of mechanism 128 or molded together and then they are cut to the preferred configuration.

Alternative methods for forming housing 112 include but are not limited to, stamping, casting, protrusion, pultrusion and injection molding. In accordance with these alternative methods of manufacture housing 112 is also capable of being formed from alternative materials including but not limited to, aluminum, polymers, plastics, rubber, steel, composites, other metals and combinations thereof (e.g. laminates and compositions of different types of materials) wherein the material used for housing 112 and the mechanisms is resilient. For example if housing 112 is formed by a stamping process the preferred material may be steel or alternatively if the preferred metal is steel the preferred process may be stamping.

Referring now to FIG. 12 an alternative embodiment of the present disclosure is illustrated, here component parts performing similar or analogous functions are labeled in multiple of 100. Here, inflator locking mechanism 228 also acts as a diffuser 256 located between inflator 214 and cushion 216. More specifically, in this embodiment mechanism 228 includes a plurality of diffuser openings 258. Openings 258 place inflator area 224 in fluid communication with cushion area 226. Opening 258 distribute inflation gases from inflator 214 to cushion 216.

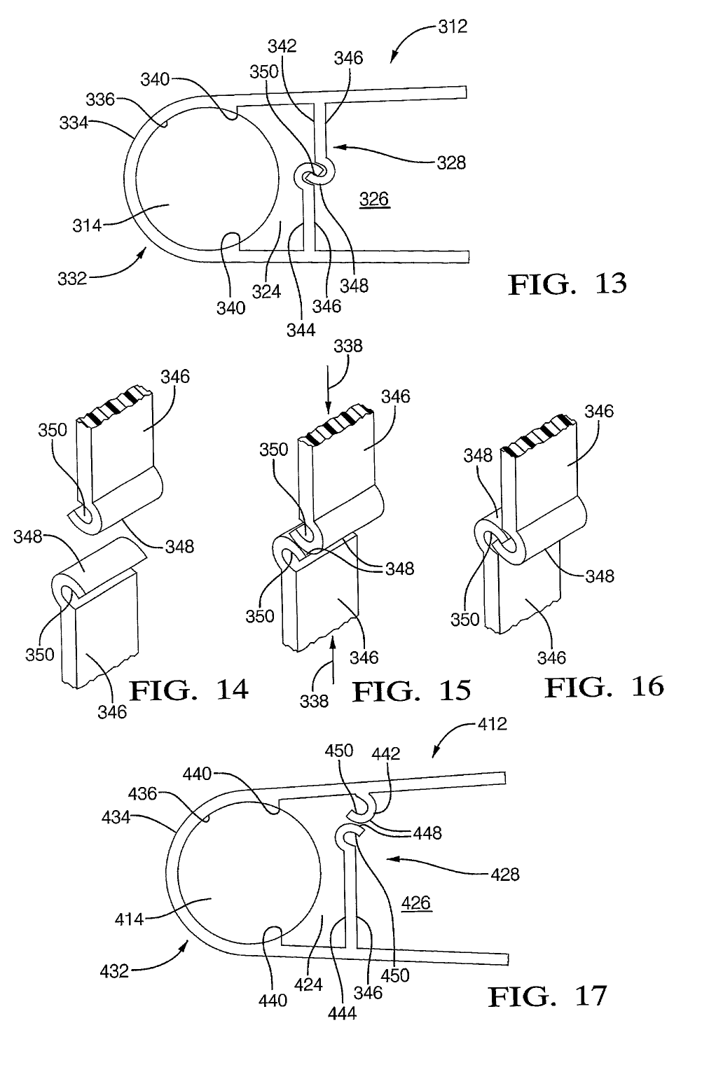

Referring now to FIGS. 13-16, another alternate embodiment of the housing is illustrated. Here, an inflator locking mechanism 328 includes a set of locking arms 342 and 344 extending from receiving area 336. Arms 342 and 344 each include a transverse section 346, a mating face 348 and a locking face 350.

As discussed above, mating faces 348 are configured to act upon one another as wall 334 is flexed to move housing 312 from open position 330 (FIG. 14) towards closed position 332 (FIG. 16). Traverse sections 346 are molded/manufactured out of a material capable of being able to flex or elastically deform while also being capable of returning to their undeformed position. Mating faces 348 act upon one another to deform sections 346 such that arm 342 moves in a first direction, while arm 344 moves in a second, opposite direction.

Once housing 312 has moved equal to or slightly past closed position 332, mating faces 348 cease to act on one another. At this point, the resiliency of traverse sections 346 return arms 342 and 344 to an unbiased state placing locking faces 350 into a locking relationship with one another.

Upon the release of closing pressure 338, the sidewalls act to bias or move housing 312 back towards open position 330. However, upon movement from its position equal to or slightly father than closed position 332, locking faces 350 mate with one another to lock housing 312 in the closed position. By way of example, FIGS. 14-16 illustrate mechanism 328 in detail before application of closing force 338 (FIGS. 14), during application of the closing force (FIG. 16), and after removal of the closing force (FIG. 13).

Accordingly, mechanisms 328 are configured to work in conjunction with inflator area 324 to secure inflator 314 in housing 312 by the compressive forces applied by receiving area 336 on the inflator. Mechanisms 328 can be configured to either have a plurality of spaced apart mechanisms as in FIG. 4, or to act as a diffuser as in FIG. 12.

Referring now to FIG. 17, an alternate exemplary embodiment of the housing is illustrated having inflator locking mechanisms 428. Mechanisms 428 include a plurality of locking arms 442 and 444 extending from the sidewalls of the housing. Arms 442 and 444 each include a mating face 448 and a locking face 450. However, in this embodiment only one of the arms, namely arm 444, includes only a transverse section 446.

Here, mating faces 448 are configured to act upon one another as the sidewalls are flexed to move housing 412 from an open position 430 towards closed position 432 while traverse section 446 is configured to flex or elastically deform. Mating faces 448 act upon one another to deform section 446 such that arm 444 moves in a first direction, while arm 442 remains substantially stationary.

Once housing 412 has moved equal to or slightly past a closed position, mating faces 448 cease to act on one another. At this point, traverse section 446 returns arm 444 to an unbiased state thereby locking faces 450 with one another.

Upon the release of the closing force, the sidewalls act to bias or move housing 412 back towards the open position. However, upon movement from its position equal to or slightly further than closed position 432, locking faces 450 mate with one another to lock housing 412 in the closed position.

The mechanism of FIG. 17 is configured to either have a plurality of spaced apart mechanisms as in FIG. 4, or to act as a diffuser as in FIG. 12.

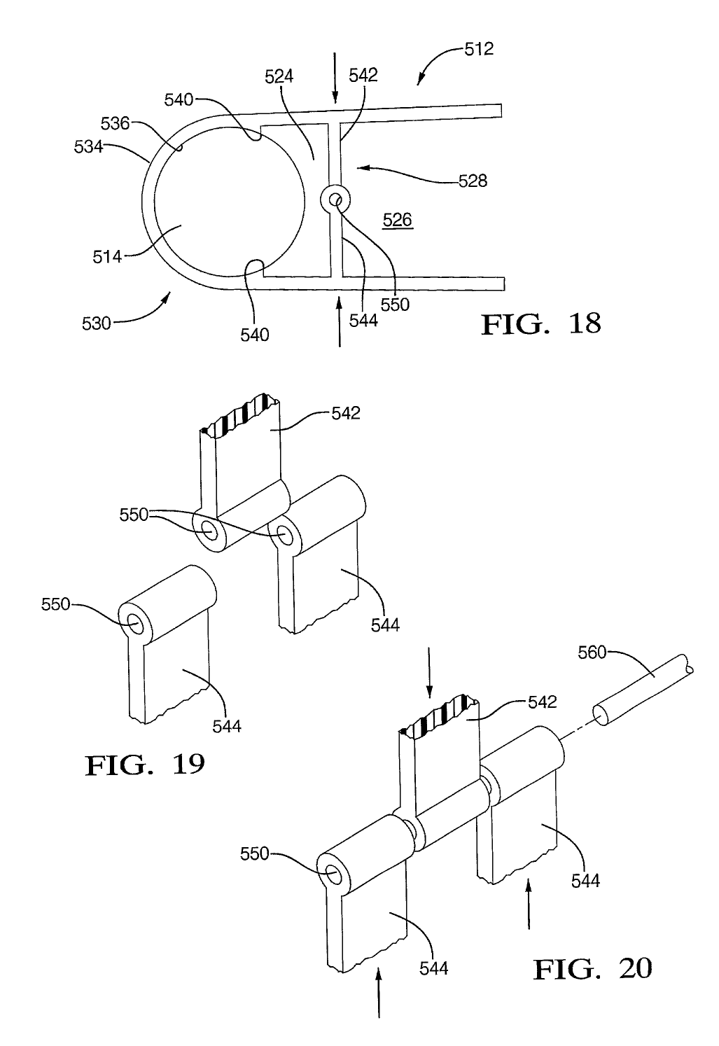

Referring now to FIGS. 18-20, another embodiment of the present disclosure is illustrated. Here mechanisms 528 include a set of locking arms 542 and 544 extending from the sidewalls. Arms 542 and 544 each include a locking hole or opening 550. Openings 550 are configured to come into axial alignment as wall 534 is flexed to move housing 512 from an open position towards a closed position 532 (FIGS. 18 and 20). Once openings 550 are axially aligned, a shaft 560 is inserted through the openings.

Shaft 550 is used to lock housing 512 in the closed position. By way of example, FIGS. 19 and 20 illustrate mechanism 528 in detail before application of closing force 538, and during application of the closing force causing holes 550 to become axially aligned.

It should be recognized that mechanism 528 is described above by way of example as having one arm 542 and two arms 544. Of course, and as applications require, multiple arms 547 and arms 544 are included in the scope of the present disclosure.

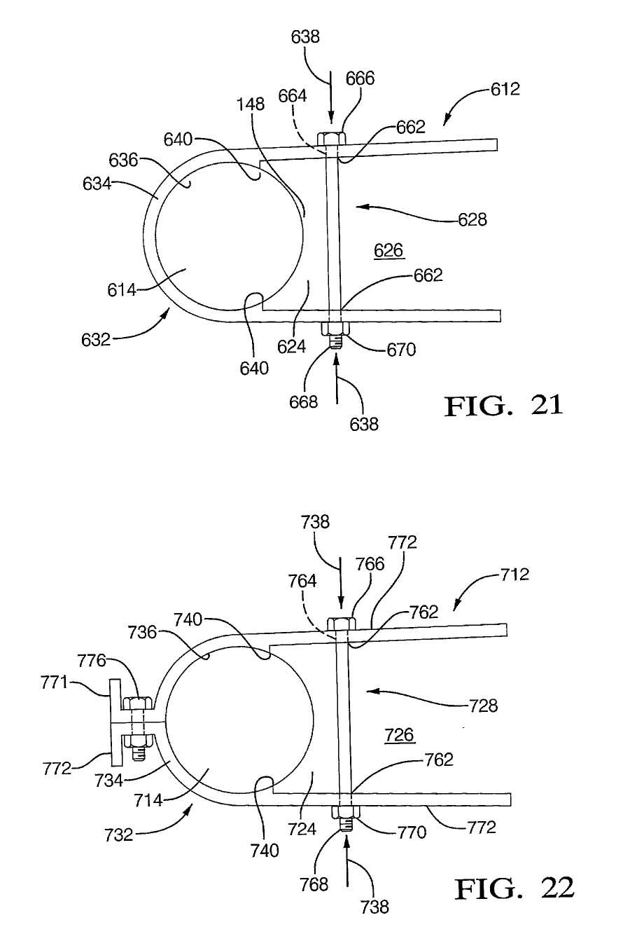

Referring now to FIG. 21, yet another alternative embodiment is illustrated. Here, housing 612 includes a pair of locking holes or openings 662 disposed on opposite sides thereof. Holes 662 are adapted to receive mechanism 628 therethrough to secure housing 612 in the closed position. Holes 662 are configured to come into axial alignment as the sidewalls are flexed to move housing 612 from an open position towards a closed position. Once holes 662 are axially aligned, a bolt 664 is inserted through the holes such that a head 665 of the bolt rests exterior to one side of housing 612, and such that a threaded end 668 protrudes through the opposite side of the housing for receiving a threaded nut 670. Accordingly, mechanism 628 locks housing 612 in closed position 632.

It should be recognized that mechanism 628 is described above by way of example as having one bolt 664. Of course, and as applications require, the inclusion of more bolts 664 is included in the scope of the present invention.

Referring now to FIG. 22, yet another alternative embodiment of the present disclosure is illustrated. Here, housing 712 includes two portions 772 each defining a portion of inflator area 724 and a portion of cushion area 726. Preferably, portions 772 are symmetrical to one another, allowing for ease of manufacture by stamping, casting, extrusion, injecting molding, pultrusion, etc., of the housing two portions.

Each portion 772 includes an outwardly extending tab portion 774. Tab portion 774 is configured to join the portions together by a securing means such as, a bolt 776. Once joined, housing 712 defines inflator area 724 and cushion area 726. Here, inflator area 724 includes a wall 734 defining a receiving area 736. The sidewalls of housing 712 are configured to flex or elastically deform from an open position to a closed position upon the application of closing force (e.g. the tightening of the bolts).

As discussed above with respect to FIG. 21, housing 712 includes a pair of locking holes 762 disposed on opposite sides thereof. Holes 762 are adapted to receive a securing means therethrough to secure housing 712 in the closed position. Holes 762 are configured to come into axial alignment as the sidewalls are flexed to move housing 712 from an open position towards a closed position. Once holes 762 are axially aligned, a bolt 764 is inserted through the holes such that a head 766 of the bolt rests exterior of one sidewall of housing 712, and such that a threaded end 768 protrudes through the opposite sidewall of the housing. The protruding portion being positioned for receiving a threaded nut 770. Accordingly, mechanism 728 locks housing 712 in a closed position.

It should be recognized that housing 712 is illustrated by way of example only. Of course, use of any of the inflator locking mechanisms described herein in conjunction with housing 712 is considered within the scope of the present application. It should also be recognized that means for connecting portions 772 other than tabs 774 and bolt 776, such as, but not limited to retaining clips, interlocking members, adhesives, welds, combination thereof, and the like, is considered within the scope of the present application.

As described in detail above, the housing is configured for ease of manufacturing through the use of an extrusion, stamping, casting, protrusion, pultrusion, injection molding or other process that produces a continuous housing that can be cut to its preferred length. In accordance with these alternative methods of manufacture the housing is also capable of being formed from alternative materials including but not limited to, polymers, steel, composites, and other metals.

As also mentioned herein, the wall, transverse sections, and/or tabs of the housing are configured to flex, elastically deform, and/or bias back toward their original position. These properties are provided for by the inherent flexibility or memory of the materials, the shape of these portions, and/or combinations thereof.

The inflator locking mechanisms, discussed above, lock the housing in the closed position to retain the inflator in the receiving area. Moreover, and in addition to securing the inflator in the housing, the inflator locking mechanism provides structural rigidity to the housing, and optionally acts to more evenly distribute inflation gases from the inflator to the cushion.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of securing an inflator in an air bag module, comprising:
inserting an inflator into a housing;
elastically deforming a portion of said housing about said inflator and causing a plurality of locking members to move from a first position to a second position, said locking members being configured to retain said housing in a configuration as said housing is deformed and said members move towards said second position.

2. An air bag housing, comprising:
a pair of sidewalls being in a facing spaced relationship;
a connecting portion being configured to connect said pair of sidewalls;
a receiving area configured to receive an air bag inflator therein, said pair of sidewalls and said connecting portion being constructed out of a resilient material that allows said pair of sidewalls and said connecting portion to be deformed from a first position to a second position, said receiving area decreasing in size as said pair of sidewalls and said connecting portion are deformed to said second position and said receiving area secures said air bag inflator therein as said pair of sidewalls and said connecting portion are deformed to said second position; and
a plurality of first locking members depending from one of said pair of sidewalls and a plurality of second locking members depending from the other one of said pair of sidewalls, said plurality of first locking members being secured to said plurality of second locking members as said pair of sidewalls and said connecting portion is deformed to said second position from said first position.

3. An air bag housing, comprising:
a pair of sidewalls and a connecting portion connecting said pair of sidewalls to each other, said pair of sidewalls defining a portion of a cushion area configured to receive an inflatable cushion in an un-inflated state;
an inflator area, said pair of sidewalls and said connecting portion defining a portion of said inflator area, said inflator area being configured to receive an inflator for inflating said inflatable cushion, said inflator area defining a receiving area, said receiving area being configured to conform to a cross section of said inflator, said pair of sidewalls and said connecting portion being configured to flex or elastically deform from an open position to a closed position upon the application of a closing force to said housing; and
an inflator locking mechanism being configured to lock said pair of sidewalls and said connecting portion in said closed position to secure said inflator in said receiving area.

4. The air bag housing of claim 3, further comprising retaining formations on an inner surface of said housing.

5. The air bag housing of claim 3, wherein said inflator locking mechanism provides structural support to the air bag housing when the air bag housing is in said closed position.

6. The air bag housing of claim 3, wherein said inflator locking mechanism is configured to have a plurality of openings for diffusion of an inflation gas being expelled from said inflator.

7. The air bag housing of claim 3, wherein said inflator locking mechanism is integral with the air bag housing.

8. The air bag housing of claim 3, wherein said air bag housing has a plurality of inflator locking mechanisms each having a pair of locking arms one of said pair of locking arms extending from one said sidewall and the other extending from the other sidewall, said locking arms each having a mating face, and a locking face, at least one of said pair of locking arms including a transverse section between the sidewall and the locking face, said transverse section being configured to flex or elastically deform, said mating faces being configured to act upon one another as said sidewalls are flexed from said open position to said closed position, said mating faces being further configured to cease acting upon one another as said wall is flexed equal to or slightly past said closed position such that said traverse section bias back to an underformed state to place said locking faces into a faced relationship with one another, said wall biasing said locking faces into a locking relationship.

9. The air bag housing of claim 3, wherein said inflator locking mechanism comprises:
a pair of first locking members extending from one of said sidewalls, said pair of first locking members each having an opening passing therein;
a second locking member extending from the other one of said side walls, said second locking member having an opening passing therein, said pair of first locking members being configured to be disposed on either side of said second locking member when said housing is in said closed position and said opening of said second locking member axially aligning with said openings of said pair of first locking members; and
a locking member being configured to pass through said openings when said housing in said closed position.

10. The air bag housing of claim 3, wherein said inflator locking mechanism comprises a securing means for securing two portions of said housing together, said securing means passing through a pair of openings in said housing, said openings being configured to be in axial alignment when said housing is in said closed position.

11. An air bag housing, comprising:
a pair of sidewalls and a connecting portion connecting said pair of sidewalls to each other, said pair of sidewalls defining a portion of a cushion area configured to receive an inflatable cushion in an uninflated state;
an inflator area, said pair of sidewalls and said connecting portion defining a portion of said inflator area, said inflator area being configured to receive an inflator for inflating said inflatable cushion, said inflator area defining a receiving area, said receiving area being configured to conform to a cross section of said inflator, said pair of sidewalls and said connecting portion being configured to flex or elastically deform from an open position to a closed position upon the application of a closing force to said housing; and
an inflator locking member being configured to lock said pair of sidewalls and said connecting portion in said closed position to secure said inflator in said receiving area, said inflator locking member passing through a pair of openings in said pair of sidewalls, said pair of openings being axially aligned when said housing is in said closed position.

12. The air bag housing of claim 11, wherein said sidewalls and said connecting portion are defined by a pair of symmetrical housing portions each being secured to the other by said inflator locking member and a locking member being configured to lock said housing portions to each other proximate to said connecting portion, said locking member passing through a pair of openings in said housing portions, said pair of openings being axially aligned when said housing portions are aligned with each other.

13. A method for increasing the structural integrity of an air bag housing, comprising:
forming an air bag housing and at least one locking mechanism out of a resilient material, said housing defining an inflator area and a cushion area, said at least one locking mechanism being disposed between said inflator area and said cushion area, said locking mechanism being configured to secured said housing in a closed position as said air bag housing is moved from an open position to a closed position.

14. The method of claim 13, wherein a receiving area of said inflator area is reduced in size from a first area to a second area as said air bag housing is moved from an open position to a closed position, said second area being smaller than said first area.

15. The method of claim 14, wherein said inflator area includes retaining formations formed therein, said retaining formations increase the surface area of said receiving area.

16. The method of claim 1, wherein said housing is extruded from aluminum stock.

17. The air bag housing as in claim 2, wherein said air bag housing is extruded from aluminum stock.

18. The air bag housing as in claim 2, wherein said air bag housing is formed by one of the following processes: extrusion, pultrusion, protrusion, stamping and injection molding.

19. The air bag housing as in claim 8, wherein said plurality of inflator locking mechanism are integral with said sidewalls.

20. The air bag housing as in claim 19, wherein said air bag housing is formed by one of the following processes: extrusion, pultrusion, protrusion, stamping and injection molding.
